(19) United States
(12) Patent Application Publication
(10) Pub. No.: US 2017/0373389 A1
(43) Pub. Date: Dec. 28, 2017

(54) ANTENNA APPARATUS AND RFID SYSTEM

(71) Applicant: Murata Manufacturing Co., Ltd., Nagaokakyo-shi (JP)

(72) Inventors: Shunji Mandai, Nagaokakyo-shi (JP); Yoichi Saito, Nagaokakyo-shi (JP)

(21) Appl. No.: 15/681,669

(22) Filed: Aug. 21, 2017

Related U.S. Application Data
(63) Continuation of application No. PCT/JP2016/051153, filed on Jan. 15, 2016.

(30) Foreign Application Priority Data
Feb. 24, 2015 (JP) 2015-033807

(51) Int. Cl. H01Q 1/52; H01Q 7/00; H01Q 1/22

(52) U.S. Cl. CPC H01Q 1/52; H01Q 1/2225; H01Q 7/00

(57) ABSTRACT

An antenna apparatus having a substrate, an antenna on the substrate, and a power supply circuit element on the substrate and connected to the antenna. The antenna includes coil-shaped first and second coil antenna units respectively having coil axes that intersect with the substrate. The first coil antenna unit and the second coil antenna unit are arranged on the substrate such that a direction in which a current flows through one of the coil antenna units is clockwise and a direction in which the current flows through the other of the coil antenna units is counterclockwise. The power supply circuit element is positioned between the first coil antenna unit and the second coil antenna unit.

### CROSS REFERENCE TO RELATED APPLICATIONS

The present application is a continuation of PCT/JP2016/051153 filed Jan. 15, 2016, which claims priority to Japanese Patent Application No. 2015-033807, filed Feb. 24, 2015, the entire contents of each of which are incorporated herein by reference.

### TECHNICAL FIELD

The present disclosure relates to an antenna apparatus, as well as an RFID system having the antenna apparatus and an RFID tag that performs wireless communication with the antenna apparatus.

### BACKGROUND

Conventionally, antenna apparatuses exist that uses electromagnetic induction to perform wireless communication with IC cards and RFID tags.

For example, the antenna apparatus described in JP11-282980A is utilized in a reader/writer for writing information to an IC card and reading information from the IC card, and includes a loop antenna for the writing or reading. The loop antenna is twisted so as to form two small loops (coils), that is, to be in an “8” shape. According to such a loop antenna, directions of magnetic fluxes respectively passing through the two coils are different. Therefore, the magnetic fluxes respectively generated by the two coils cancel each other at a position distant from the coil antenna. With this design, it is possible to suppress an influence of a magnetic field generated by the antenna apparatus on other wireless communication devices.

In general, elements within an antenna apparatus are also influenced by a magnetic field generated by an antenna of the antenna apparatus.

For example, a power supply circuit element that is connected to an antenna and supplies power to the antenna is influenced by a magnetic field generated by this antenna.

### SUMMARY

Thus, an object of the present disclosure is to provide an antenna apparatus that is used, for example, for an RFID system and is capable of reducing an influence of a magnetic field generated by an antenna of the apparatus on a power supply circuit element connected to this antenna.

In order to overcome the technical problems and limitations in conventional antenna apparatuses discussed above, an antenna apparatus is disclosed that includes a substrate; an antenna provided on the substrate; and a power supply circuit element provided on the substrate and connected to the antenna. According to the exemplary aspect, the antenna includes a first coil antenna unit and a second coil antenna unit, each having a coil axis that intersects with the substrate, where the first coil antenna unit and the second coil antenna unit are arranged on the substrate such that a direction in which a current flows through one of the coil antenna units is clockwise and a direction in which a current flows through the other of the coil antenna units is counterclockwise. Moreover, in the exemplary aspect, the power supply circuit element is provided within a region between the first coil antenna unit and the second coil antenna unit.

Another aspect of the present disclosure is to provide an antenna apparatus that includes a substrate; an antenna provided on the substrate; and a power supply circuit element provided on the substrate and connected to the antenna. In this aspect, the antenna includes a first coil antenna unit and a second coil antenna unit, with each being coil-shaped and having a coil axis that intersects with the substrate. Moreover, the first coil antenna unit and the second coil antenna unit are arranged on the substrate such that a direction in which a current flows through one of the coil antenna units is clockwise and a direction in which a current flows through the other of the coil antenna units is counterclockwise. Furthermore, in this aspect, the power supply circuit element is provided on an imaginary straight line on the substrate, with the imaginary straight line being located equidistantly from the coil axis of the first coil antenna unit and the coil axis of the second coil antenna unit.

Yet another exemplary aspect provides an RFID system that includes a product having an RFID tag; and an antenna apparatus that performs wireless communication with the RFID tag of the product. In this aspect, the antenna apparatus includes a substrate; an antenna provided on the substrate; and a power supply circuit element provided on the substrate and connected to the antenna. In this aspect, the antenna includes a first coil antenna unit and a second coil antenna unit, each being coil-shaped and having a coil axis that intersects with the substrate, where the first coil antenna unit and the second coil antenna unit are arranged on the substrate such that a direction in which a current flows through one of the coil antenna units is clockwise and a direction in which a current flows through the other of the coil antenna units is counterclockwise. Moreover, the power supply circuit element is provided within a region between the first coil antenna unit and the second coil antenna unit.

Further another exemplary aspect is to provide an RFID system that includes a product having an RFID tag; and an antenna apparatus that performs wireless communication with the RFID tag of the product. In this aspect, the antenna apparatus includes a substrate; an antenna provided on the substrate; and a power supply circuit element provided on the substrate and connected to the antenna. Moreover, the antenna includes a first coil antenna unit and a second coil antenna unit, each being coil-shaped and having a coil axis that intersects with the substrate, the first coil antenna unit and the second coil antenna unit being arranged on the substrate such that a direction in which a current flows through one of the coil antenna units is clockwise and a direction in which a current flows through the other of the coil antenna units is counterclockwise. Furthermore, the power supply circuit element is provided on an imaginary straight line on the substrate, with the imaginary straight line being located equidistantly from the coil axis of the first coil antenna unit and the coil axis of the second coil antenna unit.

According to the exemplary embodiments disclosed herein, with an antenna apparatus used, for example, for an RFID system, it is possible to reduce an influence of a magnetic field generated by an antenna of the apparatus on a power supply circuit element connected to this antenna.

### BRIEF DESCRIPTION OF THE DRAWINGS

FIG. 1 is a schematic perspective view of an RFID system according to a first exemplary embodiment 1.

FIG. 2 is an exploded view of the RFID system according to the embodiment 1.

FIG. 3 is a top view of an antenna apparatus according to the embodiment 1.

FIG. 4 is a bottom view of the antenna apparatus according to the embodiment 1.

FIG. 5 is a circuit diagram of the antenna apparatus according to the embodiment 1.

FIG. 6 is a sectional view of the antenna apparatus showing a distribution of a magnetic field generated by the antenna apparatus according to the embodiment 1.

FIG. 7 is a top view of an antenna apparatus for an RFID system according to a second exemplary embodiment 2.

FIG. 8 is a bottom view of the antenna apparatus according to the embodiment 2.

FIG. 9 is a sectional view of the antenna apparatus taken along line Q-Q in FIG. 7.

FIG. 10 is a sectional view of the antenna apparatus taken along line R-R in FIG. 7.

FIG. 11 is a block diagram illustrating a configuration of the antenna apparatus according to the embodiment 2.

FIG. 12 is a diagram for illustration of signal lines and return paths.

### DETAILED DESCRIPTION

An antenna apparatus according to an exemplary aspect includes a substrate; an antenna provided on the substrate; and a power supply circuit element provided on the substrate and connected to the antenna. In this aspect, the antenna includes a first coil antenna unit and a second coil antenna unit, each having a coil axis that intersects with the substrate, where the first coil antenna unit and the second coil antenna unit are arranged on the substrate such that a direction in which a current flows through one of the coil antenna units is clockwise and a direction in which a current flows through the other of the coil antenna units is counterclockwise. Moreover, the power supply circuit element is provided within a region between the first coil antenna unit and the second coil antenna unit.

Further, an antenna apparatus according to another exemplary aspect is disclosed that includes a substrate; an antenna provided on the substrate; and a power supply circuit element provided on the substrate and connected to the antenna. In this aspect, the antenna includes a first coil antenna unit and a second coil antenna unit, with each being coil-shaped and having a coil axis that intersects with the substrate, where the first coil antenna unit and the second coil antenna unit are arranged on the substrate such that a direction in which a current flows through one of the coil antenna units is clockwise and a direction in which a current flows through the other of the coil antenna units is counterclockwise. In this aspect, the power supply circuit element is provided on an imaginary straight line on the substrate that is located equidistantly from the coil axis of the first coil antenna unit and the coil axis of the second coil antenna unit.

According to these aspects, with an antenna apparatus used, for example, for an RFID system, it is possible to reduce an influence of a magnetic field generated by an antenna of the apparatus on a power supply circuit element connected to this antenna.

In one exemplary aspect, the power supply circuit element may include an RFIC element that sends and receives signals via the antenna.

In addition, the power supply circuit element may include a matching element that is connected to the antenna and the RFIC element. With this configuration, the RFIC element is able to perform high-quality wireless communication via the antenna.

The power supply circuit element may further include a control IC element that is connected to the RFIC element and controls the RFIC element. With this configuration, an external device connected to the antenna apparatus does not need to have a function for controlling the RFID element. Therefore, it is possible to connect the antenna apparatus to an external device without a function for controlling the RFIC element, that is, a general-purpose external device such as a computer.

If a region between the first coil antenna unit and the second coil antenna unit forms a narrowest region, according to an exemplary aspect, the RFIC element may be disposed on one side with respect to the narrowest region, the control IC element may be disposed on the other side with respect to the narrowest region, and a conductor connecting the RFIC element with the control IC element may pass through the narrowest region. With this configuration, it is possible to reduce a distance between the first coil antenna unit and the second coil antenna unit, and in turn to reduce a size of the substrate. As a result, the antenna apparatus may be made smaller.

The power supply circuit element may include a conductor-for-signal through which a signal current flows, and a conductor-for-return through which a return current for the signal current flows. In this case, it is preferable that the conductor-for-signal and the conductor-for-return are in parallel with each other, and face each other in a direction perpendicular to the substrate. With this configuration, it is possible to suppress interlinkage between magnetic fluxes of a loop-shaped circuit having a conductor-for-signal and a conductor-for-return in which a current flows around and the first coil antenna unit and the second coil antenna unit. As a result, it is possible to suppress mixture of noises into signals that flows through the conductor-for-signal.

The first coil antenna unit and the second coil antenna unit may be helical-shaped according to one exemplary aspect. With this configuration, it is possible to make an area of an opening of a coil larger. As a result, when the RFID tag or the like that wirelessly communicates with the coil antenna is placed within an opening of the coil antenna unit, it is possible to increase an area for placement.

An RFID system according to yet another exemplary aspect includes a product having an RFID tag; and an antenna apparatus that performs wireless communication with the RFID tag of the product. In this aspect, the antenna apparatus includes a substrate; an antenna provided on the substrate; and a power supply circuit element provided on the substrate and connected to the antenna, where the antenna includes a first coil antenna unit and a second coil antenna unit, each being coil-shaped and having a coil axis that intersects with the substrate, the first coil antenna unit and the second coil antenna unit are arranged on the substrate such that a direction in which a current flows through one of the coil antenna units is clockwise and a direction in which a current flows through the other of the coil antenna units is counterclockwise. Moreover, the power supply circuit element is provided within a region between the first coil antenna unit and the second coil antenna unit.

An RFID system according to another exemplary aspect includes a product having an RFID tag; and an antenna apparatus that performs wireless communication with the RFID tag of the product. In this aspect, the antenna apparatus includes a substrate; an antenna provided on the substrate; and a power supply circuit element provided on the substrate and connected to the antenna. In addition, the antenna includes a first coil antenna unit and a second coil antenna unit, each being coil-shaped and having a coil axis that intersects with the substrate, where the first coil antenna unit and the second coil antenna unit is arranged on the substrate such that a direction in which a current flows through one of the coil antenna units is clockwise and a direction in which a current flows through the other of the coil antenna units is counterclockwise. Furthermore, the power supply circuit element is provided on an imaginary straight line on the substrate that is located equidistantly from the coil axis of the first coil antenna unit and the coil axis of the second coil antenna unit.

According to these aspects, with the antenna apparatus used, for example, for the RFID system, it is possible to reduce an influence of a magnetic field generated by the antenna of the apparatus on the power supply circuit element connected to this antenna. Further, it is possible to suppress generation of a position of the RFID tag at which the RFID tag is not able to wirelessly communicate with the antenna, i.e., a null point.

If the antenna apparatus includes placement portions on each of which the product is placed, it is preferable that the placement portions are provided respectively within the first coil antenna unit and the second coil antenna unit when viewed in a direction perpendicular to the substrate. With this configuration, the RFID tag of the product and the antenna apparatus may wirelessly communicate in a favorable manner.

Hereinafter, exemplar embodiments of the present disclosure will be described with reference to the drawings.

### Embodiment 1

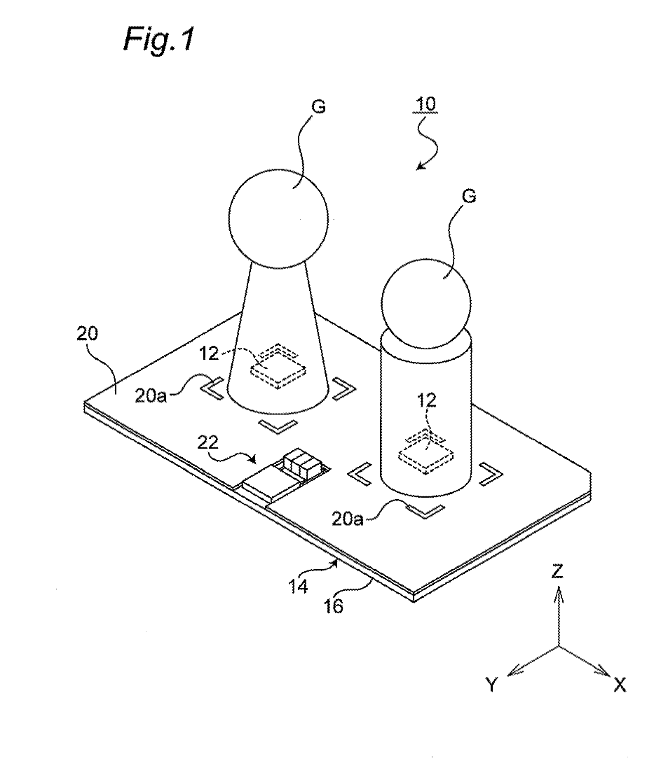

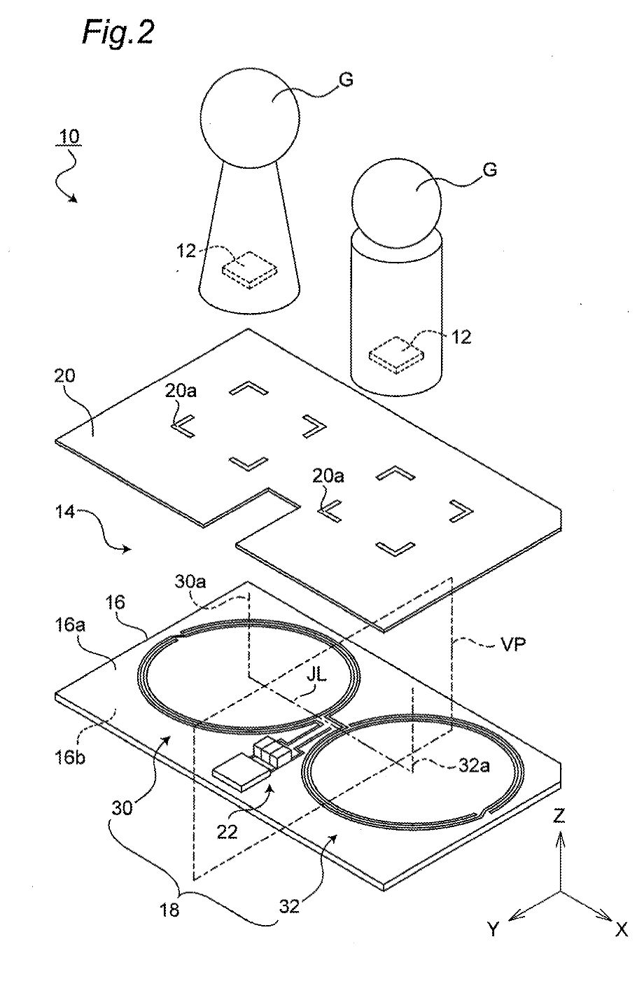

FIG. 1 schematically illustrates an RFID system according to a first exemplar embodiment 1. FIG. 2 is an exploded view of the RFID system illustrated in FIG. 1. Here, an X-Y-Z coordinate system shown in the figures is employed merely to facilitate understanding of the exemplary embodiments, and not intended to limit the present disclosure.

An RFID system 10 shown in FIG. 1 constitutes an HF band RFID system using an HF band frequency as a carrier frequency, and includes an RFID (Radio Frequency Identification) tag 12 attached to a product G, and an antenna apparatus 14 as an antenna of a reader/writer device that performs wireless communication with the RFID tag 12.

While not shown, the RFID tag 12 includes an antenna that performs wireless communication with the antenna apparatus 14, a control unit connected to the antenna, and a memory connected to the control unit. Based on a requesting signal from the antenna apparatus 14 received by its antenna, for example, the control unit of the RFID tag 12 obtains information (data) within the memory, and sends the obtained information to the antenna (that is, sends information to the antenna apparatus 14 via the antenna of the RFID tag 12). The control unit of the RFID tag 12 also writes information from the antenna apparatus 14 received by its antenna to the memory.

The antenna apparatus 14 that performs wireless communication with the RFID tag 12 includes a substrate 16, an antenna 18 provided on the substrate 16, and a cover 20 that protects the antenna 18 and on which the product G is placed. Here, the cover 20 is provided with marks 20a indicating positions of placement portions on the cover 20 on each of which the product G is placed.

The substrate 16 of the antenna apparatus 14 includes a main surface 16a and a back surface 16b that faces the main surface 16a. As an example of the substrate 16, a printed circuit board made of an epoxy resin may be used. On the main surface 16a and the back surface 16b of the substrate 16, coil antenna units 30 and 32 that constitute antennas, lands for mounting a capacitor 36 that provides a power supply circuit element 22 and an RFIC element 34, and connecting conductors 38 and 40 for connecting the coil antenna units 30 and 32 with the power supply circuit element 22 are provided as conductor patterns. The conductor patterns are patterned, for example, by etching or like a copper foil over an entire surface of the printed circuit board in a predetermined shape. The main surface 16a of the substrate 16 is provided with the antenna 18, and the power supply circuit element 22 connected to the antenna 18 and supplying power to the antenna 18.

As shown in FIG. 2, according to the exemplary aspect the antenna 18 includes the first coil antenna unit 30 and the second coil antenna unit 32 that are in a coil shape. The first and the second coil antenna units 30, 32 respectively include coil axes (winding axes) 30a, 32a that intersect with the main surface 16a of the substrate 16, for example, perpendicularly (extend along a Z axial direction). Further, the first coil antenna unit 30 and the second coil antenna unit 32 are connected in series.

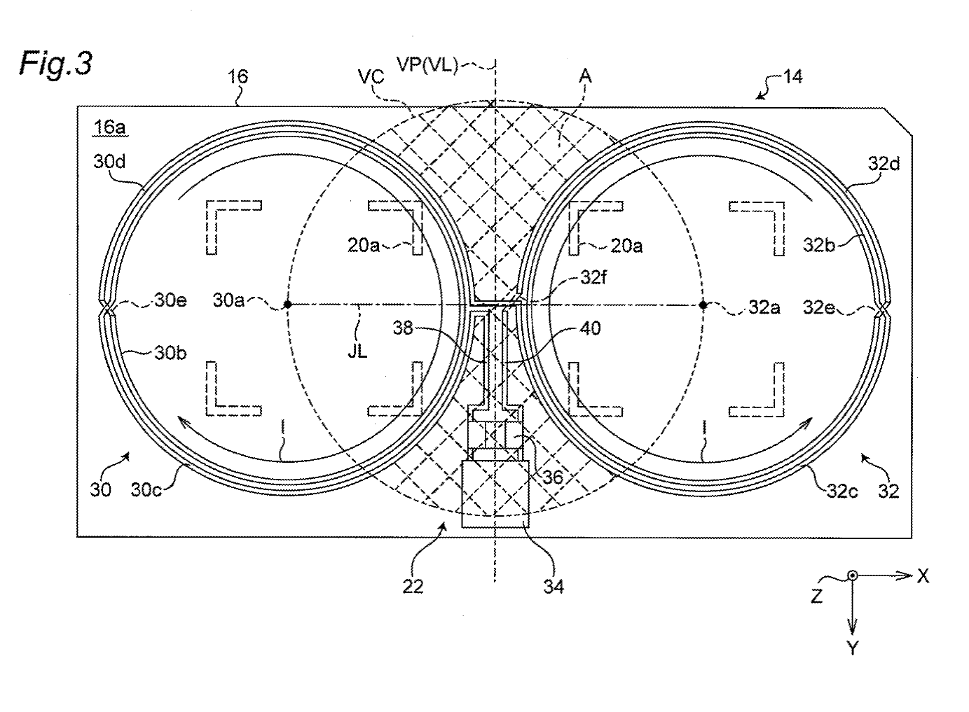

In the case of the embodiment 1, as shown in FIG. 3 which is a top view of the antenna apparatus 14, each of the first and the second coil antenna units 30, 32 is configured as a double loop conductor centered at corresponding one of the coil axes 30a, 32a. Further, the shapes of the first and the second coil antenna units 30, 32 are symmetric with respect to an imaginary plane VP that passes a midpoint of a connecting straight line JL connecting the coil axes 30a, 32a perpendicularly to the connecting straight line JL.

Here, the placement portions for products G on the cover 20, that is, the marks 20a indicating the placement portions are provided respectively within the first and the second coil antenna units 30, 32 when viewed in a direction perpendicular to the main surface 16a of the substrate 16 (Z axial direction). More specifically, centers of the marks 20a are offset to a side of the imaginary plane VP from centers of the respective coil antenna units. With this configuration, the RFID tags 12 of the products G are respectively arranged within the first and the second coil antenna units 30, 32, that is, respectively within magnetic fluxes passing the first and the second coil antenna units 30, 32. As a result, the RFID tag 12 and the antenna apparatus 14 may wirelessly communicate in a favorable manner.

Specifically, as shown in FIG. 3, the first coil antenna unit 30 includes a substantially circular inner conductor 30b which is partially disconnected (“C” shape), and two semi-circular outer conductors 30c, 30d arranged outside and along the inner conductor 30b. The two semi-circular outer conductors 30c, 30d are arranged along a circumference of the same circle centered at the coil axis 30a.

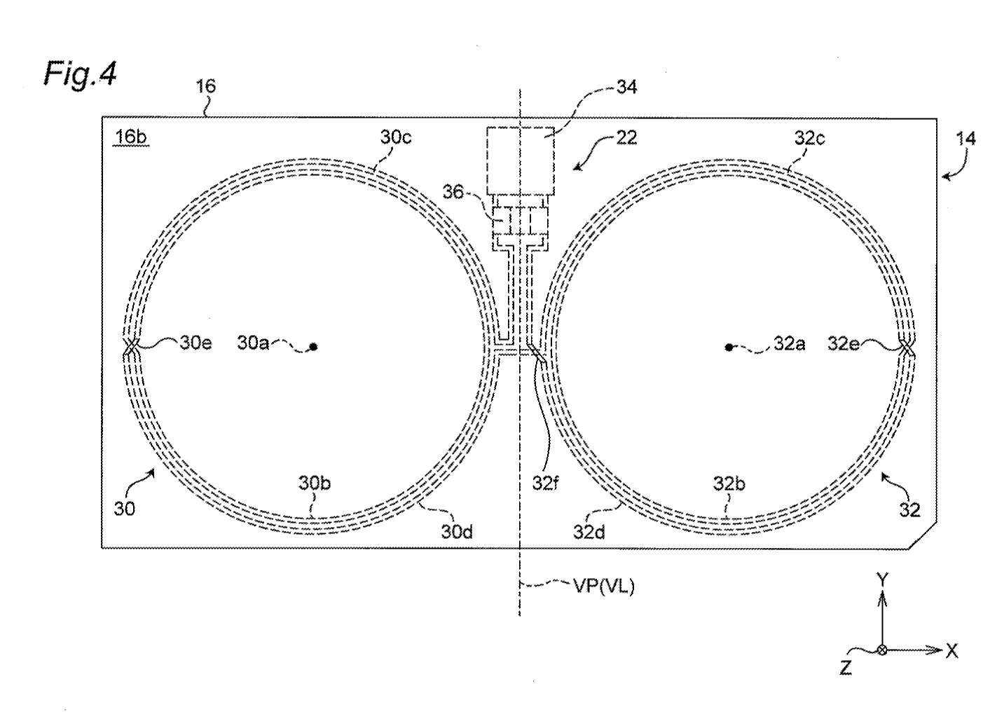

One end of the outer conductor 30c of the first coil antenna unit 30 is connected to the power supply circuit element 22. The other end of the outer conductor 30c is connected to one end of the inner conductor 30b. The other end of the inner conductor 30b is connected to one end of the outer conductor 30d via a bridge conductor 30e. As shown in FIG. 4, which illustrates a bottom view of the antenna apparatus 14, the bridge conductor 30e is provided on the back surface 16b of the substrate 16 according to the exemplary aspect. Here, the inner conductor 30b and the outer conductor 30c on the main surface 16a of the substrate 16 and the bridge conductor 30e are connected via an interlayer connecting conductor (a conductor that penetrates the substrate 16) such as a via hole conductor or a through hole conductor that is not illustrated. Further, the other end of the outer conductor 30d is connected to the second coil antenna unit 32.

Similar to the first coil antenna unit 30, the second coil antenna unit 32 includes a substantially circular inner conductor 32b which is partially disconnected (“C” shape), and two semi-circular outer conductors 32c, 32d arranged outside and along the inner conductor 32b. The two semi-circular outer conductors 32c, 32d are arranged along a circumference of the same circle centered at the coil axis 32a.

One end of the outer conductor 32c of the second coil antenna unit 32 is connected to the other end of the outer conductor 30d of the first coil antenna unit 32. The other end of the outer conductor 32c is connected to one end of the inner conductor 32b. The other end of the inner conductor 32b is connected to one end of the outer conductor 32d via a bridge conductor 32e. As also shown in FIG. 4, the bridge conductor 32e is provided on the back surface 16b of the substrate 16 according to the exemplary aspect. Further, the other end of the outer conductor 32d is connected to the power supply circuit element 22 via a bridge conductor 32f.

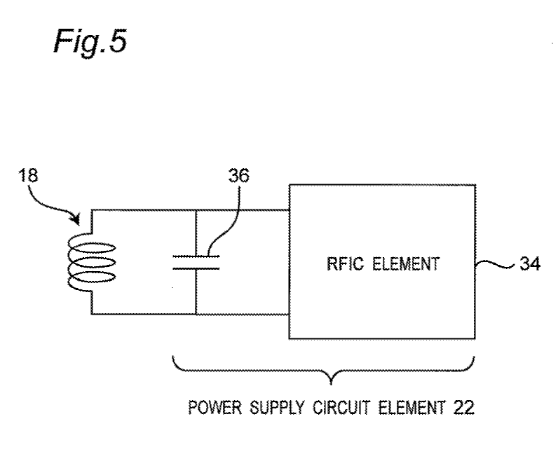

FIG. 5 is a circuit diagram of the antenna apparatus 14, showing the power supply circuit element 22 connected to the antenna 18 (the first coil antenna unit 30 and the second coil antenna unit 32).

In the case of the embodiment 1, the power supply circuit element 22 includes the RF (Radio Frequency) IC element 34 and the capacitor 36.

The RFIC element 34 is connected to the antenna 18. More specifically, the RFIC element 34 includes two input/output terminals, and the input/output terminals are respectively connected to one end and the other end of the antenna 18. The RFIC element 34 is also configured to send and receive signals via the antenna 18. For example, the RFIC element 34 receives information within the memory of the RFID tag 12 as a signal via the antenna 18 that communicates with the RFIC tag 12. Alternatively, the RFIC element 34 sends information recorded in the RFID tag 12 as a signal to the RFID tag 12 via the antenna 18.

Here, the RFIC element 34 is configured to be able to output information received from the RFID tag 12 to an external device (not shown) external to the antenna apparatus 14, and to receive an input of information from the external device. With this configuration, the antenna apparatus 14 is able to function as a reader/writer device in the RFID system 10 that reads and writes information from and to the RFID tag 12. The RFIC element includes an RFIC chip.

The capacitor 36 is connected in parallel to the coil-shaped antenna 18. This constitutes a resonant circuit configured by the coil-shaped antenna 18 and the capacitor 36. Capacitance of the capacitor 36 is determined such that a resonant frequency of the resonant circuit is a predetermined frequency (here, an HF band frequency).

According to such a configuration, as shown in FIG. 3, for example, a current I from the power supply circuit element 22 flows through the outer conductor 30c, the inner conductor 30b, and the outer conductor 30d of the first coil antenna unit 30 of the antenna 18, and the outer conductor 32c, the inner conductor 32b, and the outer conductor 32d of the second coil antenna unit 32 of the antenna 18, in that, order, according to the exemplary aspect. Further, when viewed from top of the antenna apparatus 14, the current I flows, in the clockwise direction, through the first coil antenna unit 30, and the current I flows, in the counterclockwise direction, into the second coil antenna unit 32.

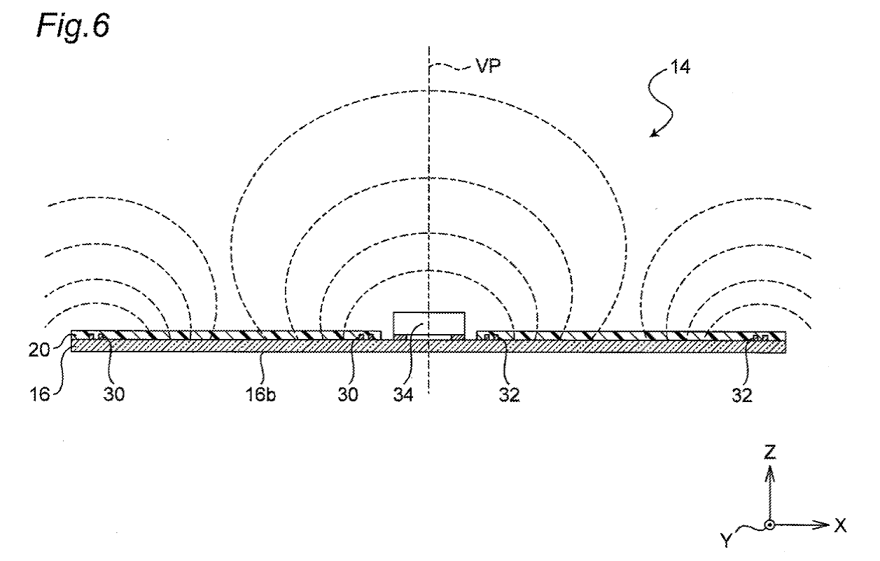

Thus, directions of a magnetic flux generated by the first coil antenna unit 30 and a magnetic flux generated by the second coil antenna unit 32 are different. A magnetic field distribution as shown in FIG. 6 is generated according to the exemplary aspect. For example, in FIG. 3, the magnetic flux passing the first coil antenna unit 30 in which the current I flows in the clockwise direction is directed from top to bottom (toward a negative direction along a Z axis). On the other hand, the magnetic flux passing the second coil antenna unit 32 in which the current I flows in the counterclockwise direction is directed from bottom to top (toward a positive direction along the Z axis).

As the directions of a magnetic flux generated by the first coil antenna unit 30 and a magnetic flux generated by the second coil antenna unit 32 are different in this manner, there is a portion on the substrate 16 at which a magnetic flux density is relatively lower than a different portion.

Specifically, as shown in FIG. 3, as compared to the different portion, the magnetic flux density is low in a region between the first coil antenna unit 30 and the second coil antenna unit 32, for example, a region A (cross-hatched region) within an imaginary circle VC centered at the midpoint of the connecting straight line JL connecting the coil axes 30a, 32a and outside the first and the second coil antenna units 30, 32. At any position within the low magnetic flux density region A, magnetic fluxes respectively generated by the first and the second coil antenna units 30, 32 cancel each other since a difference between a distance from the first coil antenna unit 30 to the any position and a distance from the second coil antenna unit 30 to the any position is small. As a result, the magnetic flux density becomes low.

By contrast, for example, in a region facing the second coil antenna unit 32 across the first coil antenna unit 30 (a region on a left side of the first coil antenna unit 30 in FIG. 3), a difference between the distances from the first and the second coil antenna units 30, 32 is large, the magnetic flux of the second coil antenna unit 32 does not cancel the magnetic flux of the first coil antenna unit 30. As a result, the magnetic flux density becomes high.

Here, the magnetic flux density is the lowest (substantially zero) at a position on the imaginary plane VP at which the distances from the first and the second coil antenna units 30, 32 are equal.

Further, as shown in FIG. 1, when a product G having the RFID tag 12 is placed above one of the first coil antenna unit 30 and the second coil antenna unit 32, the magnetic field distributions of the coil antenna units 30, 32 are not symmetric with respect to the imaginary plane VP. In this case, the magnetic flux density in the low magnetic flux density region A changes as well. However, an amount of change in the magnetic flux density in this area is smaller than that in the region outside the low magnetic flux density region A.

As shown in FIG. 3, the connecting conductors 38 and 40 that provide the conductor patterns provided on the substrate 16 as well as the RFIC element 34 and the capacitor 36 of the power supply circuit element 22 are positioned within the low magnetic flux density region A. In the case of the embodiment 1, the power supply circuit element 22 is provided at a position on an imaginary straight line VL on the substrate 16 at which the distances from the first and the second coil antenna units 30, 32 (i.e., the coil axes 30a, 32a) are equal. Here, the imaginary straight line VL is a line of intersection between the imaginary plane VP and the main surface 16a of the substrate 16.

It should be noted that, in the case of the embodiment 1, as shown in FIG. 3, a terminal of the first coil antenna unit 30 and a terminal of the second coil antenna unit 32 of the antenna 18 (i.e., one ends of the outer conductor 30c, 32d) are located within the low magnetic flux density region A. Therefore, similar to the power supply circuit element 22, the connecting conductor 38 connecting the terminal of the first coil antenna unit 30 to the power supply circuit element 22 and the connecting conductor 40 connecting the terminal of the second coil antenna unit 32 to the power supply circuit element 22 are also provided within the low magnetic flux density region A. Specifically, connecting portions to the power supply circuit element 22 in the antenna 18 are also provided within the low magnetic flux density region A.

Therefore, the RFIC element 34 of the power supply circuit element 22 and the connecting conductors 38, 40 are insusceptible to the magnetic fluxes as compared to a case in which these components are provided outside the low magnetic flux density region A. With this configuration, noises attributed to the antenna 18 may not be easily mixed with signals output from the RFIC element 34. Further, noises attributed to the antenna 18 may not be easily mixed with signals input to the RFIC element 34. As a result, a communication quality of the RFID system 10 including the antenna apparatus 14 is highly reliable according to the configuration of the exemplary embodiment.

According to the embodiment 1 described above, with the antenna apparatus 14 used for the RFID system 10, it is possible to reduce an influence of a magnetic field generated by the antenna 18 of the apparatus on the power supply circuit element 22 connected to the antenna 18.

Further, In the case of the embodiment 1, the antenna 18 includes the two coil antenna units 30, 32. With this configuration, it is possible to suppress generation of a position of the RFID tag 12 at which the RFID tag 12 is not able to wirelessly communicate with the antenna 18, i.e., a null point.

When lengths of the conductors are the same, an area of an opening of one coil antenna unit (an area within the conductor of the coil) is larger than an area of an opening of each of the two coil antenna units. If the area of the opening is larger, a magnetic flux density at a center of the coil antenna unit that is distant form from the conductor is low, and a null point where antenna sensitivity is low occurs at this position.

By contrast, when the same currents flow, magnetic flux densities at centers of two coil antenna units are higher than the magnetic flux density at the center of the one coil antenna unit. Therefore, it is possible to suppress generation of a null point more effectively by two coil antenna units than by one coil antenna unit if the lengths of the conductors and the currents flowing therethrough are the same.

### Embodiment 2

Differences between an RFID system of according to an embodiment 2 and the RFID system 10 according to the embodiment 1 lie in the antenna apparatus. In particular, configurations of an antenna and a power supply circuit element are different from those in the embodiment 1. Therefore, the embodiment 2 will be described focusing on the configurations of the antenna and the power supply circuit element different from the embodiment 1.

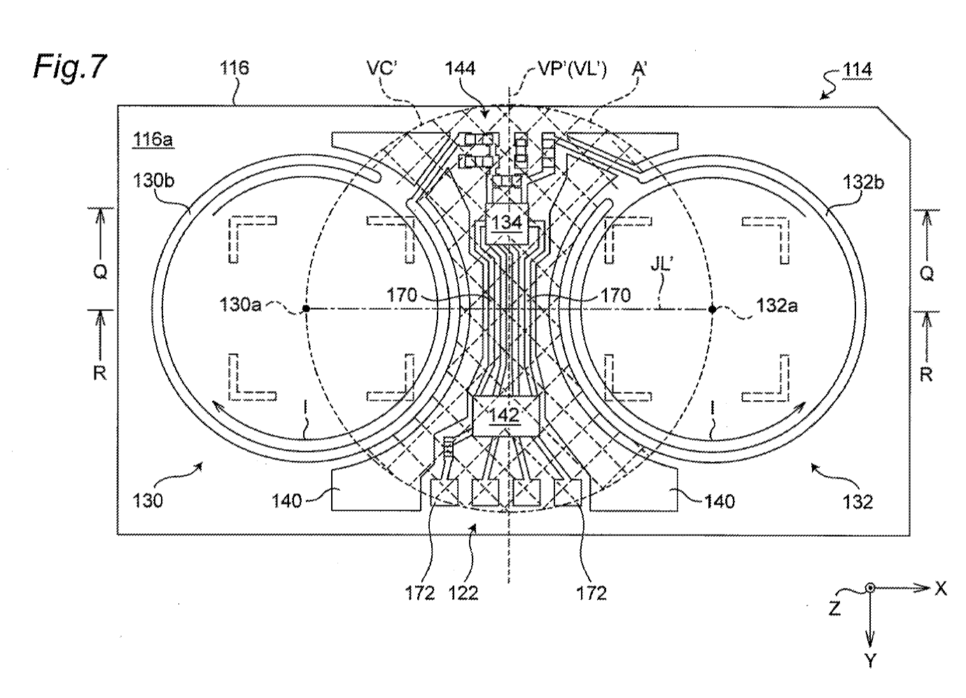

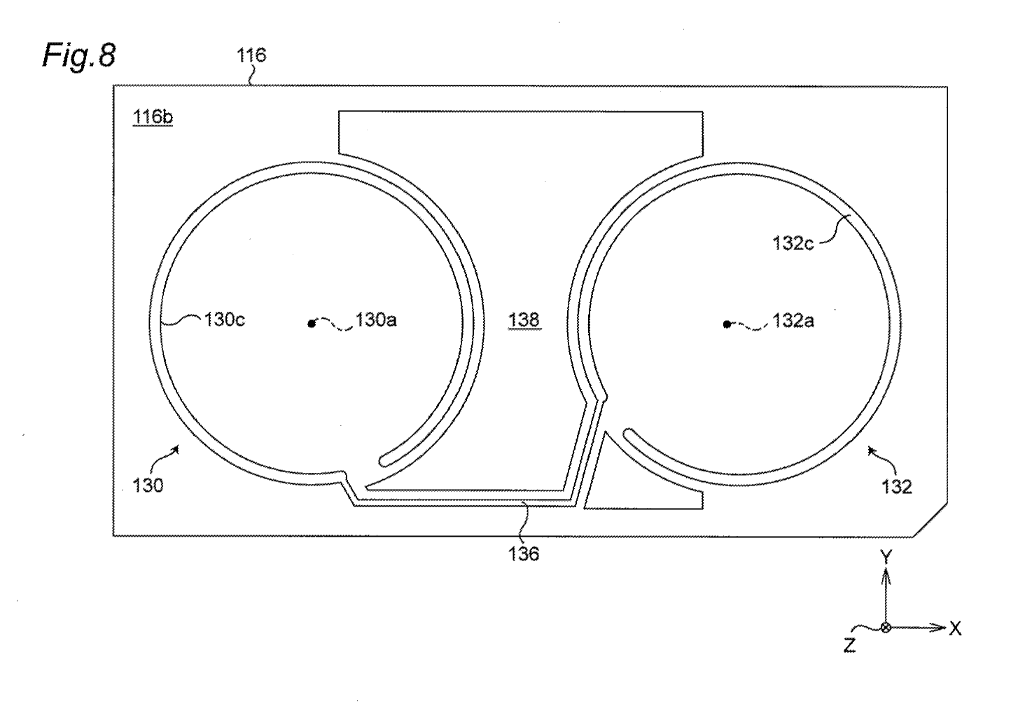

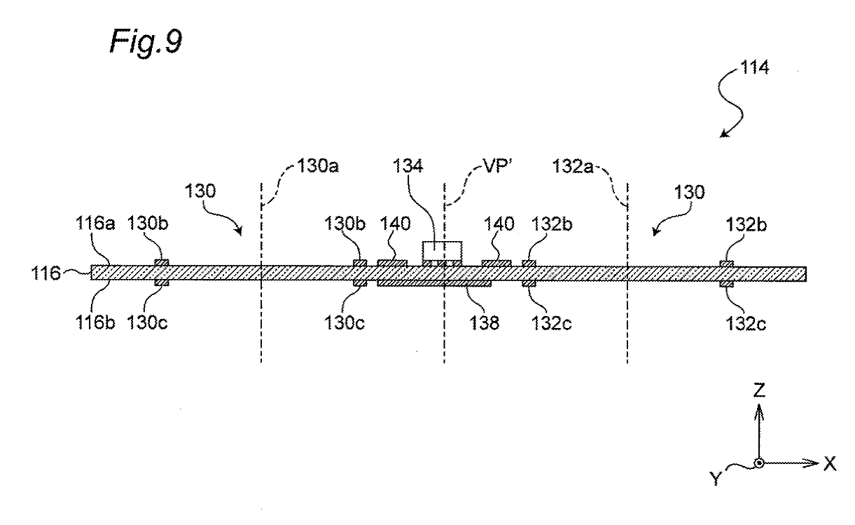

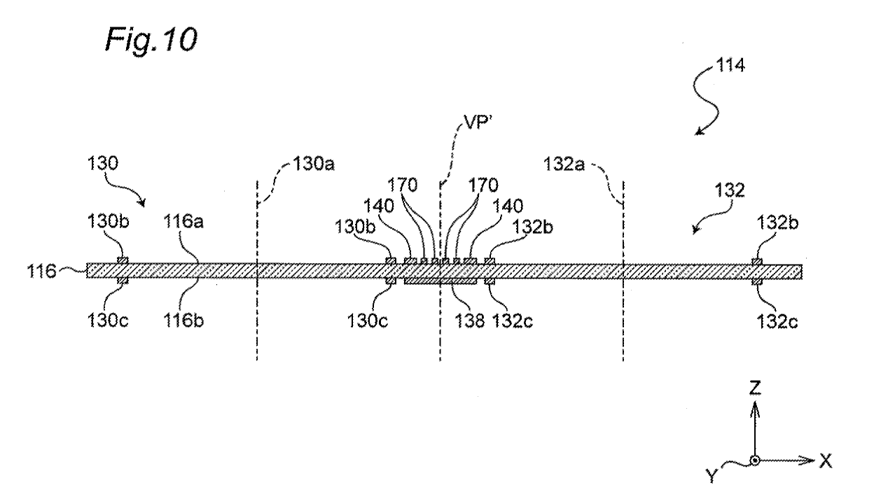

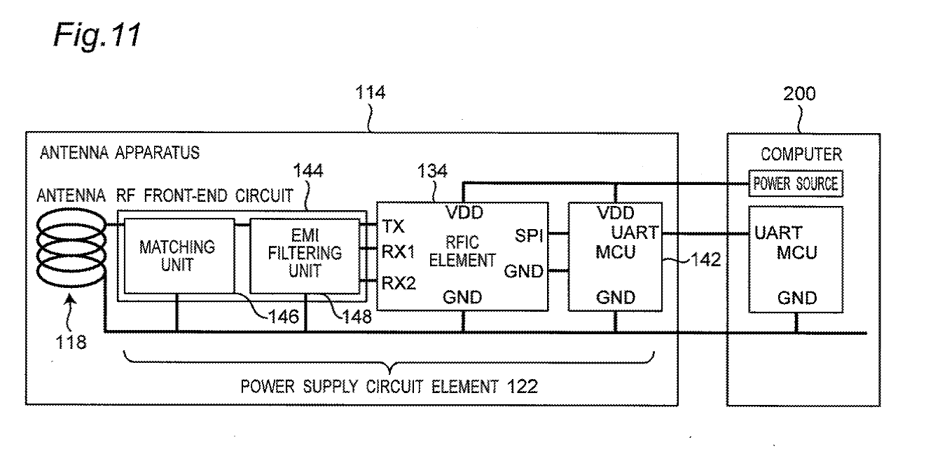

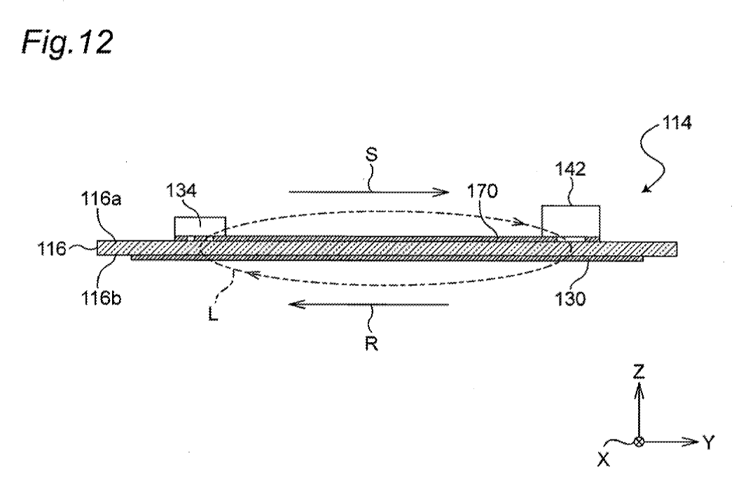

FIG. 7 is a top view of an antenna apparatus 114 according to the embodiment 2. FIG. 8 is a bottom view of the antenna apparatus 114. FIG. 9 is a sectional view taken along line Q-Q in FIG. 7. FIG. 10 is a sectional view taken along line R-R in FIG. 7. FIG. 11 is a block diagram illustrating a configuration of the antenna apparatus 114. Finally, FIG. 12 is a circuit diagram of a part of the antenna apparatus 114.

As shown in FIG. 7, an antenna 118 of the antenna apparatus 114 according to the embodiment 2 includes a first coil antenna unit 130 and a second coil antenna unit 132 respectively having the coil axes 130a, 132a perpendicular to a main surface 116a of a substrate 116. Further, the first coil antenna unit 130 and the second coil antenna unit 132 are connected in series.

The first and the second coil antenna unit 130, 132 of the embodiment 2 are helical-shaped, unlike the double loop first coil antenna units 30, 32 of the embodiment 1.

Specifically, the first coil antenna unit 130 includes a “C”-shaped main-side conductor 130b which is provided on the main surface 116a of the substrate 116, and a substantially circular back-side conductor 130c which is provided on a back surface 116b of the substrate 116 and partially disconnected (“C” shape).

One end of the main-side conductor 130b of the first coil antenna unit 130 is connected to an RFIC element 134 of a power supply circuit element 122 that will be later described in detail. The other end of the main-side conductor 130b is connected to one end of the back-side conductor 130c via a hole conductor (not shown). The other end of the back-side conductor 130c is connected to the second coil antenna unit 132.

On the other hand, the second coil antenna unit 132 includes a “C”-shaped main-side conductor 132b which is provided on the main surface 116a of the substrate 116, and a substantially circular back-side conductor 132c which is provided on a back surface 116b of the substrate 116 and partially disconnected (“C” shape).

One end of the back-side conductor 132c of the second coil antenna unit 132 is connected to the other end of the back-side conductor 130c of the first coil antenna unit 130 via a connecting conductor 136. The other end of the back-side conductor 132c is connected to one end of the main-side conductor 132b via a via hole conductor (not shown). Then, the other end of the main-side conductor 132b is connected to the RFIC element 134.

According to such a configuration, for example, a current from the RFIC element 134 flows through the main-side conductor 130b, and the back-side conductor 130c of the first coil antenna unit 130, and the back-side conductor 132c, and the main-side conductor 132b of the second coil antenna unit 132, in that order according to the exemplary embodiment. Further, when viewed from top of the antenna apparatus 114, in FIG. 7, the current I flows, in the clockwise direction, through the first coil antenna unit 130, and the current I flows, in the counterclockwise direction, into the second coil antenna unit 32.

Thus, a magnetic flux passing the first coil antenna unit 130 in which the current I flows in the clockwise direction is directed from top to bottom (toward a negative direction along a Z axis). On the other hand, the magnetic flux passing the second coil antenna unit 132 in which the current I flows in the counterclockwise direction is directed from bottom to top (toward a positive direction along the Z axis). As a result, as compared to the different portion, the magnetic flux density is low in a region between the first coil antenna unit 130 and the second coil antenna unit 132, for example, a low magnetic flux density region A′ within an imaginary circle VC′ centered at a midpoint of a connecting straight line JL′ connecting the coil axes 130a, 132a and outside the first and the second coil antenna unit 130, 132.

Here, the magnetic flux density is the lowest (substantially zero) at a position on the imaginary plane VP′ at which the distances from the first and the second coil antenna units 130, 132 are equal.

As shown in FIG. 7, the power supply circuit element 122 is provided within the low magnetic flux density region A′. Here, as shown in FIG. 8, a grand pattern 138 is provided on a portion of the back surface 116b of the substrate 116 facing the power supply circuit element 122, that is, a region between the first coil antenna unit 130 and the second coil antenna unit 132 on the back surface 116b. Further, a grand pattern 140 is provided on the main surface 116a of the substrate 116 so as to face the grand pattern 138 and to surround the power supply circuit element 122.

As shown in FIG. 7 and FIG. 11, the power supply circuit element 122 of the embodiment 2 includes the RFIC element 134 that sends and receives signals via the antenna 118 (the first and the second coil antenna units 130, 132), and an MCU (Micro Controller Unit) 142 as a control IC element that is connected to the RFIC element 134 and controls the RFIC element 134. The power supply circuit element 122 also includes an RF (Radio Frequency) front-end circuit 144 that is provided between and connected to the antenna 118 and the RFIC element 134.

The RF front-end circuit 144 includes a matching unit 146 (as shown in FIG. 11, for example) for impedance matching between the antenna 118 and the RFIC element 134, and an EMI (Electro Magnetic Interference) filtering unit 148 for noise rejection. By the RF front-end circuit 144, the RFIC element 134 is able to perform high quality wireless communication with an RFID tag via the antenna 118.

The MCU 142 sends and receives signals (information) with the RFIC element 134 to control the RFIC element 134. Therefore, a plurality of conductors 170 connecting the MCU 142 and the RFIC element 134 is arranged on the substrate 116.

In the case of the embodiment 2, as shown in FIG. 7, the RFID element 134 and the MCU 142 are provided at a position on an imaginary straight line VL′ on the substrate 116 at which distances from the first and the second coil antenna units 130, 132 (i.e., coil axes 130a, 132a) whose magnetic flux density due to the first and the second coil antenna units 130, 132 is substantially zero are equal. Here, the imaginary straight line VL′ is a line of intersection between an imaginary plane VP′ and the main surface 116a of the substrate 116. Further, the RFIC element 134 is located on one side with respect to a narrowest region within a region between the first coil antenna unit 130 and the second coil antenna unit 132 (i.e., constriction in the low magnetic flux density region A′). On the other hand, the MCU 142 is located on the other side with respect to the narrowest region. Therefore, the plurality of conductors 170 connecting the RFIC element 134 and the MCU 142 pass the narrowest region.

According to such an arrangement, the plurality of conductors 170 connecting the RFIC element 134 and the MCU 142 are arranged at positions where the magnetic flux density is low, and thus insusceptible to the magnetic field. Therefore, noises are not easily mixed in signals carried by the conductors 170. Further, as almost all of the grand patterns are arranged in the low magnetic flux density region A′, no significant influence is given to communication characteristics of the antenna.

Further, as compared to a case in which the RFIC element 134 and the MCU 142 are located on the same side with respect to the narrowest region within the region between the first coil antenna unit 130 and the second coil antenna unit 132, it is possible to make a distance between the first coil antenna unit 130 and the second coil antenna unit 132 smaller. With this configuration, a size of the substrate 116 may be reduced, and as a result, it is possible to make the antenna apparatus 114 small.

According to the exemplary aspect of embodiment 2, the RFIC element 134 and the MCU 142 are connected to the grand pattern 138 provided on the back surface 116b of the substrate 116. Further, as shown in FIG. 10, the plurality of conductors 170 arranged on the main surface 116a of the substrate 116 and connecting the RFIC element 134 and the MCU 142 faces the grand pattern 138 in a direction perpendicular to the main surface 116a of the substrate 116 (Z axial direction). Moreover, the plurality of conductors 170 and the grand pattern 138 are in parallel with each other according to the exemplary embodiment. Therefore, as shown in FIG. 12, when a signal current S flows through the conductors 170, a return current R directed oppositely to the signal current S flows through the grand pattern 138 as a return path.

Specifically, a loop L including the RFIC element 134, the conductors 170, the MCU 142, and the grand pattern 138 (return path) through which a current flows around is occurred. The loop L is perpendicular to the main surface 116a of the substrate 116. With this configuration, interlinkages of the magnetic fluxes of the first and the second coil antenna units 130, 132 into the loop L may be suppressed. As a result, it is possible to suppress mixture of noises due to the magnetic fluxes of the first and the second coil antenna units 130, 132 into signals carried by the conductors 170.

As shown in FIG. 11, the MCU 142 is connected to an external device outside the antenna apparatus 114, for example, a computer 200. The MCU 142 is configured to receive power supply for driving from the computer 200, and to send and receive signals (information) with the computer 200. For example, the MCU 142 receives information recorded in the memory of the RFID tag 12 from the computer 200. As shown in FIG. 7, as an interface for connection to the computer 200, the antenna apparatus 114 includes a plurality of connecting terminals 172 connected to the MCU 142 and arranged on the main surface 116a of the substrate 116.

According to the embodiment 2 described above, similar to the embodiment 1, with the antenna apparatus 114 used for the RFID system, it is possible to reduce an influence of a magnetic field generated by the antenna 118 of the apparatus on the power supply circuit element 122 connected to the antenna 118. Further, similar to the embodiment 1, it is possible to suppress generation of a position of the RFID tag 12 at which the RFID tag 12 is not able to wirelessly communicate with the antenna 118, i.e., a null point.

Moreover, according to the exemplary aspect of embodiment 2, the MCU 142 as a control IC element, which controls the RFIC element 134, is incorporated into the antenna apparatus 114. Therefore, an external device connected to the antenna apparatus 114 does not need to have a function for controlling the RFID element 134. Therefore, it is possible to connect the antenna apparatus 114 to an external device without a function for controlling the RFIC element 134, that is, a general-purpose external device such as a computer. Specifically, the antenna apparatus 114 of the embodiment 2 is more versatile than that of the embodiment 1.

As described above, the present invention has been described with reference to the embodiments. However, embodiments of the present invention are not limited to the above examples.

For example, in the case of the embodiment 1, as shown in FIG. 3, the first and the second coil antenna units 30, 32 are in a double looped shape (spiral shape). Further, in the case of the embodiment 2, the first and the second coil antenna units 130, 132 are helical-shaped as shown in FIG. 7 and FIG. 8. However, embodiments of the present invention are not limited to specific shapes of the plurality of coil antenna units. Specifically, as long as a region having a lower magnetic flux density than in other regions may be provided by magnetic fluxes respectively generated from the plurality of coil antenna units cancelling each other, between the coil antenna units, shapes and sizes of the coil antenna units, a winding number (i.e., a number of the loops) and a stacking number (the number of stacks of the loop) of the coils can be different according to various exemplary aspects.

However, when the coil antenna units are helical-shaped as in the embodiment 2, it is possible to make the area of an opening of the coil (an area within the conductor of the coil) larger as compared to the multi-loop shape as in the embodiment 1 (when sizes of the substrates for which the coil antenna units are provided are the same). Therefore, as shown in FIG. 2, it is possible to increase an area for placement on which a product having an RFID tag is placed and set within the opening of the coil antenna unit. Further, providing a larger number of winding of the coils (the number of the loops) is more preferable as it leads to generation of a stronger magnetic field, that is, a communication range of the antenna increases. Moreover, as shown in the above embodiments, it is preferable that the internal or external shape of the coil antenna units is circular, as this makes the magnetic field distribution even, and a null point may not easily be generated.

Furthermore, in the case of the embodiments 1 and 2, two coil antenna units for the antenna are provided, but 2 or more coil antenna units may be provided. For example, 2 or more coil antenna units may be arranged in series or in parallel.

Further, in the case of the embodiments 1 and 2 described above, the first coil antenna unit and the second coil antenna unit of the antenna are connected in series. Specifically, a current supplied from the power supply circuit element and passing one of the coil antenna units also passes the other of the coil antenna unit. Unlike the above example, the antenna apparatus may be configured such that a current is supplied from the power supply circuit element to each of the first coil antenna unit and the second coil antenna unit separately.

Moreover, in the case of the embodiments 1 and 2 described above, the antenna apparatus is able to wirelessly communicate with RFID tags respectively of two products, as shown in FIG. 1. However, it is understood that the antenna apparatus is able to wirelessly communicate with a RFID tag of one product as long as it is within the communication range of the antenna. Further, within the communication range of the antenna, the antenna apparatus is able to wirelessly communicate with the RFID tag without placing the product G on the placement portion of the antenna apparatus, that is, with a gap interposed between the antenna and the product. Therefore, a product having an RFID tag is not limited to a product such as a toy that can be placed on the antenna apparatus, and may be a card, for example. Preferably, a placement surface for the product G of the substrate 16 is the back surface 16b, instead of the main surface 16a on which the power supply circuit element 22 is provided. In other words, as design and convenience may be improved by flattening the placement surface for the product G, it is preferable to use a surface opposite to the mounting surface for the power supply circuit element 22 as the placement surface for the product G.

In addition, in the case of the embodiments 1 and 2 described above, the antenna apparatus is able to function as a reader/writer device in the RFID system that reads and writes information from and to the RFID tag. However, embodiments of the present invention are not limited to such an example. The antenna apparatus according to the embodiments of the present invention may be used, for example, in a communication system in which antenna apparatuses wireless communicates with each other. Further, the antenna apparatus is not limited to the use in the HF band RFID system, and may be used as an antenna apparatus for UHF band RFID system or the like.

Finally, as used herein, an “element” is not limited to a chip-like component, and may be interpreted as an individual component that constitutes an electrical circuit. Therefore, examples of the “element” are not limited to a chip-like component, and include circuits of patterns provided on the substrate. If the element is chip-like, the element may be mounted on the main surface or the back surface of the substrate, or built within the substrate.

Further, it is possible to achieve a new embodiment by partially combining the embodiments 1 and 2. For example, the MCU 142 of the embodiment 2 may be mounted on the antenna apparatus 14 of the embodiment 1.

The present invention may be applied to antenna apparatuses for sending and receiving information, as well as systems that employ such an antenna apparatus, for example, RFID systems and communication systems.

1. An antenna apparatus comprising:
a substrate;
a power supply circuit element disposed on the substrate; and
an antenna disposed on the substrate and connected to the power supply circuit element, the antenna including a first coil antenna unit and a second coil antenna unit, each antenna unit having a coil axis that intersects with the substrate, the first coil antenna unit and the second coil antenna unit being disposed at respective positions on the substrate such that a direction in which a current flows through one of the coil antenna units is clockwise and a direction in which a current flows through the other of the coil antenna units is counterclockwise,
wherein the power supply circuit element is disposed at a position on the substrate and within a region between the first coil antenna unit and the second coil antenna unit.

2. The antenna apparatus according to claim 1, wherein the power supply circuit element includes an RFIC element configured to transmit and receive signals via the antenna.

3. The antenna apparatus according to claim 2, wherein the power supply circuit element includes a matching element that is connected to the antenna and the RFIC element.

4. The antenna apparatus according to claim 2, wherein the power supply circuit element includes a control IC element that is connected to the RFIC element and is configured to control the RFIC element.

5. The antenna apparatus according to claim 4, wherein
the first and second coil antenna units are circular shaped and are disposed in a planar configuration adjacent to each other on the substrate,
a region where the first and second coil antenna units are closest to each other in a planar direction of the substrate defines a narrowest region,
the RFIC element is disposed at a position on the substrate on one side of the narrowest region,
the control IC element is disposed at a position on the substrate at an other side of the narrowest region, such that the RFIC element and the control IC element are disposed on opposite sides of the narrowest region, and
a conductor is disposed on the substrate and passes through the narrowest region to connect the RFIC element with the control IC element.

6. The antenna apparatus according to claim 1,
wherein the power supply circuit element includes a conductor-for-signal through which a signal current flows, and a conductor-for-return through which a return current for the signal current flows, and
wherein the conductor-for-signal and the conductor-for-return are in parallel with each other, and face each other in a direction perpendicular to the substrate.

7. The antenna apparatus according to claim 1, wherein the first coil antenna unit and the second coil antenna unit are helical-shaped.

8. The antenna apparatus according to claim 1, wherein each of the first and second coil antenna units includes a first coil conductor disposed on a first surface of the substrate on which the power supply circuit element is disposed, a second coil conductor disposed on a second surface of the substrate opposite the first surface, and a bridge conductor extending through the substrate and connecting the first coil conductor to the second coil conductor.

9. The antenna apparatus according to claim 1, wherein a low magnetic flux density region is provided above the substrate at a position where respective magnetic fluxes of the first and the second coil antenna units cancel each other out, and wherein the power supply circuit element is disposed in the low magnetic flux density region.

10. The antenna apparatus according to claim 1, wherein the coil axis of each of the first and second coil antenna units extends in a direction perpendicular to the substrate and each of the first and second coil antenna units comprise symmetric shapes with respect to each other relative to an imaginary plane passing a midpoint of a connecting straight line connecting the respective coil axes.

11. An antenna apparatus comprising:
a substrate;
a power supply circuit disposed on the substrate; and
an antenna disposed on the substrate and coupled to the power supply circuit, the antenna including a first coil antenna and a second coil antenna, with each coil antenna being coil-shaped and having a coil axis that intersects the substrate,
wherein the first coil antenna and the second coil antenna are configured on the substrate such that a current provided by the power supply circuit flows through the first coil antenna in a clockwise direction and flows through the second coil antenna in a counterclockwise direction, and
wherein the power supply circuit is positioned on the substrate on an imaginary straight line that is located equidistantly from the coil axis of the first coil antenna and the coil axis of the second coil antenna.

12. The antenna apparatus according to claim 11, wherein the power supply circuit includes an RFIC element configured to transmit and receive signals via the antenna.

13. The antenna apparatus according to claim 12, wherein the power supply circuit includes a matching element that is connected to the antenna and the RFIC element.

14. The antenna apparatus according to claim 12, wherein the power supply circuit includes a control IC element that is connected to the RFIC element and is configured to control the RFIC element.

15. The antenna apparatus according to claim 14, wherein
the first and second coil antennas are circular shaped and are disposed in a planar configuration adjacent to each other on the substrate,
a region where the first and second coil antennas are closest to each other in a planar direction of the substrate defines a narrowest region,
the RFIC element is disposed at a position on the substrate on one side of the narrowest region,
the control IC element is disposed at a position on the substrate at an other side of the narrowest region, such that the RFIC element and the control IC element are disposed on opposite sides of the narrowest region, and
a conductor is disposed on the substrate and passes through the narrowest region to connect the RFIC element with the control IC element.

16. The antenna apparatus according to claim 11, wherein each of the first and second coil antennas includes a first coil conductor disposed on a first surface of the substrate on which the power supply circuit is disposed, a second coil conductor disposed on a second surface of the substrate opposite the first surface, and a bridge conductor extending through the substrate and connecting the first coil conductor to the second coil conductor.

17. The antenna apparatus according to claim 11, wherein a low magnetic flux density region is provided above the substrate at a position where respective magnetic fluxes of the first and the second coil antennas cancel each other out, and wherein the power supply circuit is disposed in the low magnetic flux density region.

18. An RFID system comprising:
a product having an RFID tag; and
an antenna apparatus that performs wireless communication with the RFID tag of the product, the antenna apparatus including:
a substrate;
a power supply circuit disposed on the substrate; and
an antenna disposed on the substrate and connected to the power supply circuit, the antenna including a first coil antenna unit and a second coil antenna unit, each antenna unit being coil-shaped and having a coil axis that intersects with the substrate, the first coil antenna unit and the second coil antenna unit being disposed at respective positions on the substrate such that a current provided by the power supply circuit flows through the first coil antenna unit in a clockwise direction and flows through the second coil antenna units in a counterclockwise direction, and
wherein the power supply circuit is disposed at a position on the substrate between the first coil antenna unit and the second coil antenna unit.

19. The RFID system according to claim 11, wherein the power supply circuit is positioned on the substrate on an imaginary straight line that is located equidistantly from the coil axis of the first coil antenna unit and the coil axis of the second coil antenna unit.

20. The RFID system according to claim 18, wherein the antenna apparatus includes placement portions on each of which the product is placed, and wherein the placement portions are provided respectively over the first coil antenna unit and the second coil antenna unit when viewed in a direction perpendicular to the substrate.
